(19) United States
(12) Patent Application Publication
(10) Pub. No.: US 2005/0270287 A1
(43) Pub. Date: Dec. 8, 2005

(54) Image processing

(75) Inventor: Kenichiro Yasutomi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA SEGA SEGA CORPORATION

(21) Appl. No.: 11/142,245

(22) Filed: Jun. 2, 2005

(30) Foreign Application Priority Data
Jun. 3, 2004 (JP) 2004-165530

(51) Int. Cl. G06T 15/40; G06T 15/00

(52) U.S. Cl. 345/422

(57) ABSTRACT

Provided is image processing technology capable of avoiding image degradation even when a luminous body model is expanded on a three-dimensional virtual space. This image processing method generates a two-dimensional image obtained by performing perspective projection to an image model disposed in a virtual three-dimensional space on a perspective view plane 14 in a view coordinate system of a view point 12 set in the virtual three-dimensional space. The luminous body disposed in the virtual three-dimensional space is configured from a model 18 having a distance component Z in the direction from the luminous source coordinate toward the view plane, and having a cone shape extending in a direction intersecting with the direction in the view plane side, and the center image of the luminous body and the diffused light image emitted therefrom are drawn on the object.

### BACKGROUND OF THE INVENTION

1. Field of the Invention

The present invention generally relates to image processing for displaying a luminous body model in a three-dimensional space, and in particular to image processing technology enabling a more realistic representation of radiated light and flares from the luminous body.

2. Description of the Related Art

As this kind of related technology, for instance, there is a game device described in Japanese Patent No. 3,415,416. This game device is a game device for moving the view point in a three-dimensional virtual space and displaying an image of the scene coming into view. This game device has a flare processing unit for forming a flare in the image when a light source exists in the field of view of the viewpoint, and this flare processing unit includes a view (line) vector generation unit for obtaining the view vector representing the view direction of the view point, a unit for obtaining an light vector representing the direction of the light source from the view point, an inner product calculation unit for calculating the inner product of the view vector and light vector, and a flare formation unit for forming a flare having an intensity according to the inner product in the image. When a virtual light source exists in the three-dimensional virtual space and the optical line of the light source is facing the camera, a flare based on the incident optical line to the camera lens is generated in the image, and a bright screen corresponding to the state of a backlight can be created.

Conventionally, with this kind of image processing device, a two-dimensional luminous body model such as the sun was defined in a three-dimensional coordinate system defined by a computer, and the center image of the sun and pictures of diffused light radiated from the sun were affixed thereto. Although a scene where the light radiated from the luminous body being diffused, such as when the sun would be exposed from the shadows, was represented by linearly expanding the two-dimensional luminous body model, this would cause the center image (circular light source) of the luminous body to also become expanded. Thus, in addition to the resolution of the center image becoming deteriorated, there is a problem in that the size of the luminous body would change from a dot to a circle, and the quality of the appearance of the luminous body model would also deteriorate. Even though there is hardly any influence if the resolution of the diffused light radiated from the luminous body becomes deteriorated, it is desirable to avoid the deterioration in the resolution of the luminous body itself (sun, light bulb or the like) as much as possible.

### SUMMARY OF THE INVENTION

In light of the above, an object of the present invention is to provide image processing technology capable of avoiding such image degradation even when the luminous body model is expanded on the three-dimensional virtual space,

As described above, the present invention is an image processing method for generating a two-dimensional image obtained by performing perspective projection to an image model disposed in a virtual three-dimensional space on a perspective view plane (projective plane) in a view coordinate system of a view point set in the virtual three-dimensional space, wherein the luminous body disposed in the virtual three-dimensional space is configured from a model having a distance component (size, length, width) in the direction from the luminous source coordinate toward the view plane, and having a shape extending in a direction intersecting with the direction in the view plane side, and the center image of the luminous body and the diffused light image emitted therefrom are drawn on the object.

According to the present invention, since the foregoing model is configured as described above, upon expanding the luminous body model, the diffused light emitted from the center image can be expanded without hardly having to expand the center image disposed near the center of such model by increasing the size of the view point of the model to the ending point of the view plane side. Therefore, a more realistic image of the luminous body can be formed.

### BRIEF DESCRIPTION OF THE DRAWINGS

FIG. 1 is a hardware block diagram of the game machine to which the image processing pertaining to the present invention is employed;

FIG. 2 is a diagram showing a state where a luminous body model defined in a three-dimensional space is formed from a cone shaped model configured from a plurality of polygons;

FIG. 3 is a projected image of the model illustrated in FIG. 2;

FIG. 4 is a diagram showing a luminous body;

FIG. 5 is a side view of the luminous body model showing a state where the texture of the luminous body is attached to the inner peripheral face of the cone shaped model;

FIG. 6 is a perspective view of the flare model for explaining this flare model;

FIG. 7 is a perspective view of the luminous body model showing a state where the size of the luminous body model is enlarged in a virtual three-dimensional coordinate system;

FIG. 8 is a projected image of FIG. 7;

FIG. 9 is a diagram showing a state where a solar model is covered with a shield;

FIG. 10 is a diagram showing the second state thereof;

FIG. 11 is a diagram showing the relationship of the degree (phase of eclipse) of the solar model being covered with the shield and the size (Z) of the luminous body model in the Z direction;

FIG. 12 is a characteristic diagram showing the relationship of the r value and the transparency (a) of the luminous body model;

FIG. 13 is a characteristic diagram showing the relationship of the r value and Z value of the flare model;

FIG. 14 is a perspective view of the flare model pertaining to the state where the z value of the flare model is enlarged;

FIG. 15 is a characteristic diagram showing the relationship between the r value and transparency (a) of the flare model; and

FIG. 16 is an operation flowchart of the game device.

### DETAILED DESCRIPTION OF THE PREFERRED EMBODIMENTS

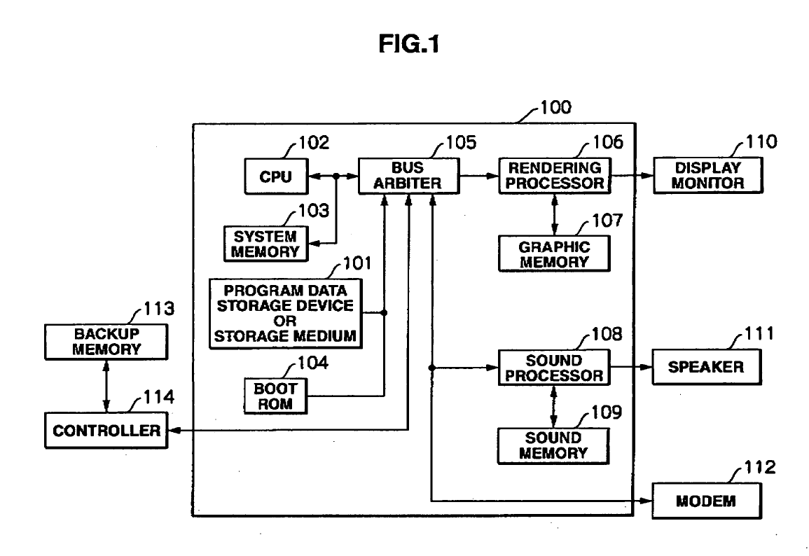

FIG. 1 is a block diagram of the game device to which the present invention is applied. The game device 100 has a storage device or storage medium (including optical disks and optical disk drives) 101 storing game programs and data (including visual and audio data), a CPU 102 for executing the game program and controlling the overall system as well as performing coordinate calculation for displaying images, a system memory 103 storing programs and data required for the CPU 102 to perform processing, a BOOTROM 104 storing programs and data required for activating the game device 100, and a bus arbiter 105 for controlling the programs and flow of data with the respective blocks of the game device 100 or the equipment to be connected externally, and these are respectively connected via a bus.

A rendering processor 106 is connected to the bus, and the visual (movie) data read out from the program data storage device or storage medium 101 and images to be created according to the player's operation or game progress are displayed on a display monitor 110 with the rendering processor 106. Graphic data and the like required for the rendering processor 106 to create images are stored in the graphic memory (frame buffer) 107.

A sound processor 108 is connected to the bus, and the audio data read out from the program data storage device or storage medium 101 and sound effects and audio to be created according to the player's operation or game progress are output from a speaker 111 with the sound processor 108. Audio data and the like required for the sound processor 106 to generate sounds are stored in the sound memory 109.

The game device 100 is connected to a modem 112, and is capable of communicating with other game devices 100 and network servers via a LAN adapter or the like. Further, a backup memory 113 (including a disk storage medium and storage device) for recording information on the progress of the game and program data to be input/output via a modem, and a controller 114 for inputting to the game device 100 information for controlling the game device 100 and equipment connected externally according to the player's operation are also connected to the game device 100. The CPU and rendering processor constitute the image arithmetic processing unit. The CPU executes the image processing described later based on a game program or game data.

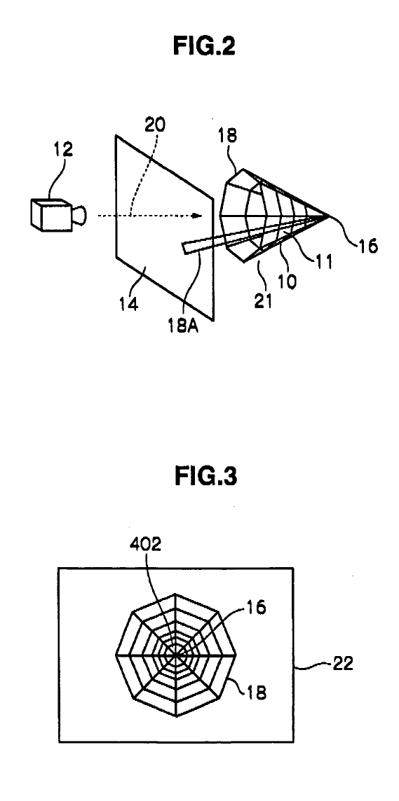

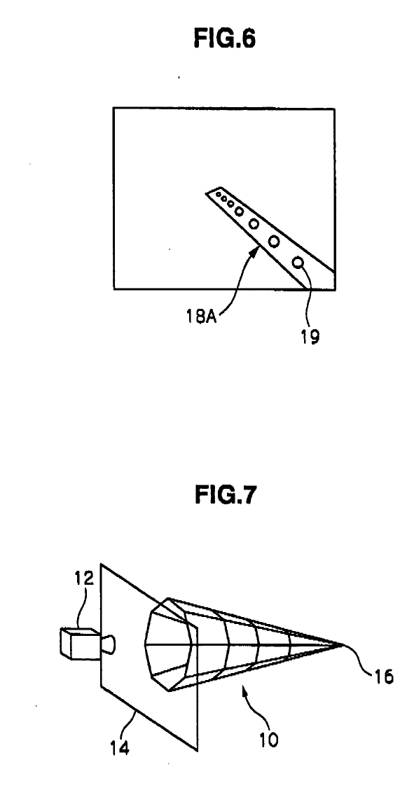

FIG. 2 Is a diagram showing a state where a luminous body model (sun) Is defined in a virtual space created in a computer hardware resource with the CPU of the game device illustrated in FIG. 1, and formed from a polyhedral pyramid shaped model, whereby this model is represented from an oblique angle. This model 10 is configured from a polyhedral pyramid shape built from a plurality of polygons 11. Reference numeral 16 is the starting point (tip) of this model, and this is set to be the positional coordinate of the light source. Reference numeral 18 is the ending point (dead end, terminal). Reference numeral 12 is the camera viewpoint defined in a virtual space, and, as shown in FIG. 3, a two-dimensional image of the luminous body model is displayed by performing perspective projection on the perspective view plane in the view coordinate system of the view point. In FIG. 2, a flare image texture 19 as illustrated in FIG. 6 is affixed to the rectangular model (flare model) represented with reference numeral 18A. FIG. 6 is a diagram showing the projected image of the flare model.

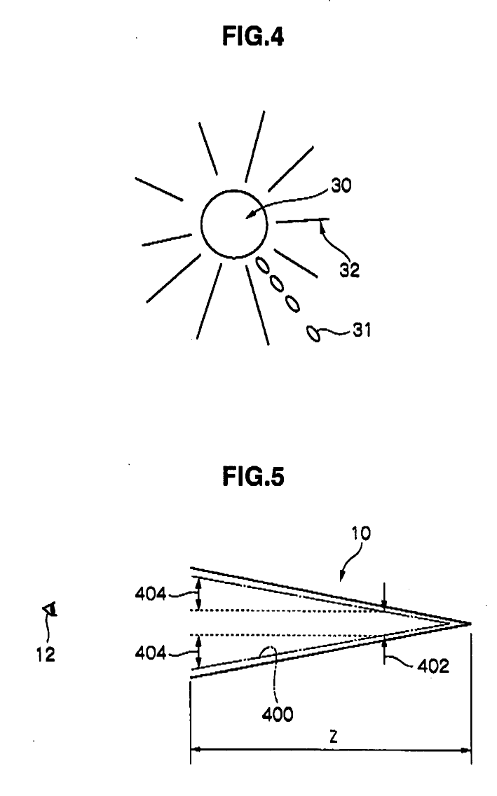

In FIG. 2, reference numeral 14 is the view plane, and this view plane is positioned perpendicular to the view (line) direction 20 from the view point toward the light source coordinate. The luminous body model expresses a mode where the diameter is expanding in relation to the view direction 20, and this diameter is radially expanding from the starting point toward the ending point. A picture (texture) of the luminous body is affixed to the inner peripheral face of the pyramid model illustrated in FIG. 2. This texture is configured from a center image and diffused light diffusing radially from such center image. FIG. 4 is a diagram showing the configuration of this texture, and reference numeral 30 is the sun itself; that is, the heat source, and reference numeral 32 is the diffused light. Reference numeral 31 represents the flare image. As shown in FIG. 5, the texture 400 illustrated in FIG. 5 is affixed to the inner peripheral face of the pyramid model 10 depicted in FIG. 3. With the two-dimensional projected image subject to perspective transformation with the starting point 12 facing the model 10, a center image corresponding to the heat source is represented in the range shown with the arrow of reference numeral 402, and diffused light is displayed in the range represented with reference numeral 404.

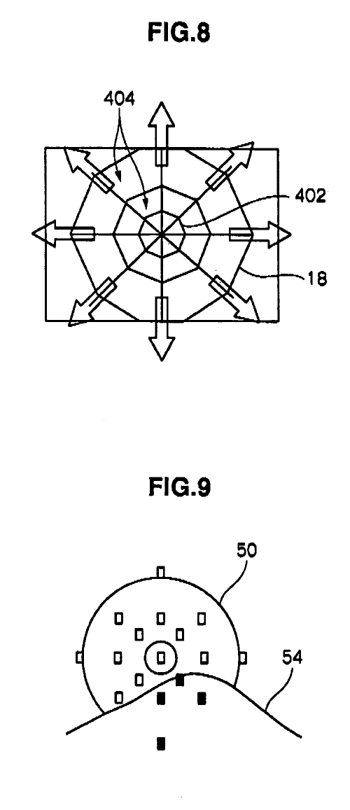

The luminous body model illustrated in FIG. 2 has a distance component (Z component) from the positional coordinate (starting point) 16 of the light source toward the view plane 14; that is, toward the view direction 20, and the value of this Z component can be changed to match the intended state of the luminous body model. FIG. 7 is a diagram showing a state where the Z value of the model 10 is expanded, and FIG. 8 is a diagram showing the projected image thereof. As shown in FIG. 8, via perspective transformation, the area (c.f. FIG. 3 and FIG. 5) to which the center image texture is displayed will be roughly the same size as the area 402 of FIG. 3 before the expansion of the Z value and will hardly be expanded, and, therefore, the resolution of such area will be maintained. Contrarily, the peripheral area 404 to which the diffused light is represented will be rapidly expanded. Here, since the diffused light will be drawn on the entire view plane, for instance, when reproducing the appearance of sudden and intense diffused light from the sun such as in a case where the view point 12 is moved and the sun is suddenly exposed from the shadows, the processing shown in FIG. 7 and 8 is employed. Meanwhile, for example, when reproducing a state where the exposure of the sun is small or the diffused light from the sun is light such as on a cloudy day, in comparison to FIG. 7, the Z value of the model 10 is set small as shown in FIG. 2. In this state, as shown in FIG. 3, the ratio of the projected image of the sun on the view plane will be small in comparison to the case depicted in FIG. 8.

The flare model 18A (FIG. 2) constitutes a part of the luminous body model, and, in addition to the rectangular shape described above, this may also be a pyramid shape. Incidentally, a flare is not formed across the enter periphery of the diffused light, and it will suffice so as long as it can be displayed in a prescribed direction. Thus, the flare model has been formed in a rectangular shape as described above. The Z value of the flare model can also be changed similar to the main model 10 of the luminous body. The purpose of placing this flare is to improve the presentation effect upon representing the flare image when the luminous body begins to expose itself from the obstacle or begins to hide behind the obstacle.

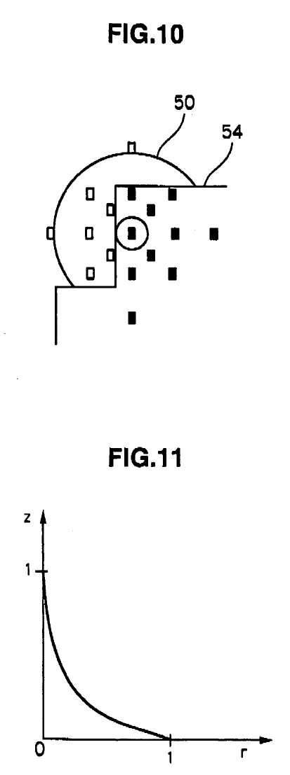

The Z value of the luminous body model 10 and flare model 18A will be adjusted based on the degree of exposure of the luminous body. FIG. 9 is a diagram showing a state where the sun 50 is hiding behind a mountain (obstacle) 52, and FIG. 10 is a diagram showing a state where the sun 50 is hiding behind a building 54. The degree of hiding (corresponds to the term “phase of eclipse” in the claims”) (r) is determined by how many of the plurality of reference points 53 defined in relation to the sun 50 are hidden behind the obstacle.

In the example of FIG. 9, since 4 among the 17 reference points are hiding behind the obstacle, r=4/17, and, in the example of FIG. 10, since 10 reference points are hidden, r=10/17. The position of the sun is determined as follows. Since the direction of the sun in the three-dimensional coordinate space is nearly determined, the two-dimensional position of the sun on the view plane can be determined as a result thereof. Simultaneously, the position of the obstacle on the view plane is also determined. As shown in FIG. 9 and FIG. 10, the position of the reference points of the sun is determined, and the Z buffer value of these reference points 53 and the Z buffer value of the obstacle 52 are compared so as to count the number of reference points hiding behind the obstacle.

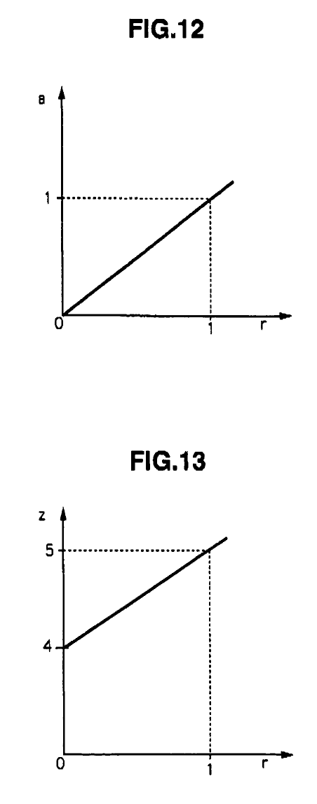

The Z value, which is the size of the cone shaped model of the luminous body in the view direction, and the degree of hiding are made to be a related parameter, and with the model illustrated in FIG. 2, the ratio of the X, Y, Z coordinate values are defined as [1,1, (1−r)²], and the relationship of the Z value and r is defined with the characteristic (Z=a·(1/r)) shown in FIG. 11. Therefore, the higher the degree of hiding, the smaller the Z value. When the Z value becomes small, as shown in FIG. 3, the view (drawing area of the diffused light) of the sun on the screen will become small. Contrarily, when the degree of hiding becomes low, the Z value will increase, and the drawing area of the diffused light of the sun will become large. When the degree of hiding is high, since the diffused light from the light source must be represented lightly, a transparency parameter is used. In other words, the higher the degree of hiding, the greater the transparency of the luminous body. FIG. 12 is a diagram showing that the relationship of the transparency a and r is a=r. The lower the degree of hiding, the transparency of the luminous body is lowered, and the luminous body is drawn densely.

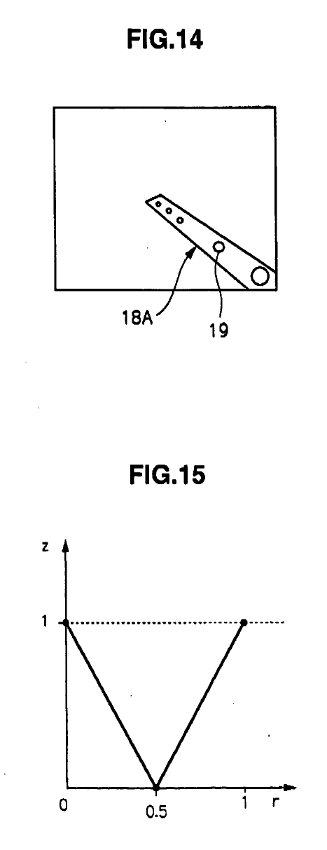

With the lens flare model (18A of FIG. 2) also, the Z value or transparency is changed according to r, and, as shown in FIG. 13, the Z value is changed within a range of roughly 4 to 5 times the standard size. Pursuant to the increase of the degree of hiding r, as shown in FIG. 14, the flare model is extending in the Z direction The transparency is gradually changed from r=0.5 as shown in FIG. 5. What is important here is that when r increases, the transparency decreases (does not have to become 0), and when r increases even more, the transparency increases. Thus, this does not necessarily have to be 0.5.

A flare model is drawn the moment the sun enters or exits the obstacle. With the flare model, the ratio of coordinates X, Y, Z is defined with [1, 1, r+4], a=2|0.5−r|. As shown in FIG. 2, the flare model 18A is protruding from the luminous body model 10, and is drawn with an emphasis in relation to the diffused light of the luminous body.

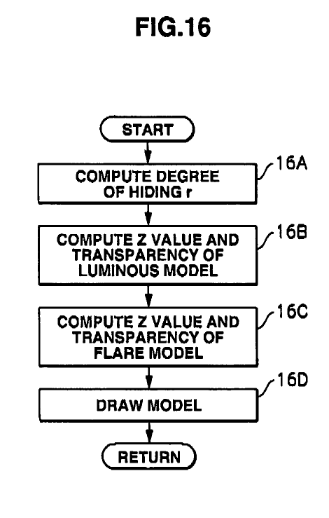

FIG. 16 is a block diagram showing the image processing operation to be realized by the CPU executing the game program. At step 16A, as shown in FIG. 9 and FIG. 10, the degree of hiding r is computed. At step 16B, the Z value and transparency are computed regarding the luminous body model. At step 16C, the Z value and transparency regarding the flare model are computed. At step 16D, the luminous body model and flare model are drawn.

Here, as the view point moves and the luminous body is gradually exposed from the obstacle and the degree of exposure progresses, the change from FIG. 3 to FIG B; that is, the size of the diffused light on the screen will increase. At the moment the sun is exposed 50%, as shown in FIG. 15, a clear flare image is drawn. During the process of the sun becoming further exposed, although the size of the diffused light will increase, the flare image will gradually disappear.

As described above, in the present embodiment, although a case has been explained where the foregoing cone shaped model is adapted as the luminous body, the present invention is not limited thereto, and the cone shaped model may also be applied to an object other than the luminous body in which the peripheral area thereof is to be expanded while the center portion thereof is not to be expanded,

According to the present invention, a cone shaped object can be used to represent the sun (luminous body) and lens flare without having to calculate the position and light source of each and every lens flare. The moment the sun comes into view, the cone is reduced and displayed brightly, and then the cone is extended, made transparent, and the brightness is lowered. The cone shaped model may also be rotated around the axis in the Z direction according to the movement of the view point. As a result, a more realistic lens flare can be represented. Since the representation of a plurality of lens flares can be reproduced with a single object, the calculation load of the CPU can be reduced.

1. An image processing method for generating a two-dimensional Image obtained by performing perspective projection to an image model disposed in a virtual three-dimensional space on a perspective view plane in a view coordinate system of a view point set in said virtual three-dimensional space, wherein the luminous body disposed in said virtual three-dimensional space is configured from a model having a distance component in the direction from the luminous source coordinate toward said view plane, and having a shape extending in a direction intersecting with said direction in said view plane side, and the center image of said luminous body and the diffused light image emitted therefrom are drawn on said object.

2. The method according to claim 1, wherein said model is configured from a three-dimensional figure expanding radially from said luminous source to the terminal of said view plane side.

3. The method according to claim 1, wherein said model is configured by further comprising a flare model with a flare image drawn thereon to be superimposed on said three-dimensional figure, and the starting point of this flare model is disposed on said luminous source side, which is the starting point of said three-dimensional figure.

4. The method according to claim 2 or claim 3, wherein said three-dimensional figure is configured from a cone shaped model.

5. The method according to any one of claims 2 to 4, wherein said luminous body changes the distance from the starting point to the ending point of said model according to the phase of eclipse showing the degree of hiding based on an obstacle positioned on said view point side.

6. The image processing method according to claim 5, wherein the transparency of said object is changed according to said phase of eclipse.

7. An image processing device configured such that an image processing circuit, based on an image processing program stored in a memory, generates a two-dimensional image obtained by performing perspective projection to an image model disposed in a virtual three-dimensional space on a perspective view plane in a view coordinate system of a view point set in said virtual three-dimensional space, and displays this on a display device, wherein said image processing circuit executes means for configuring the luminous body disposed In said virtual three-dimensional space from a model having a distance component in the direction from the luminous source coordinate toward said view plane, and having a shape extending in a direction intersecting with said direction in said view plane side, and means for drawing the center image of said luminous body and the diffused light image emitted therefrom on said object.

8. A recording medium having recorded thereon a program for making a computer execute the respective means according to claim 7.

9. A program for making a computer execute the respective means according to claim 8.

10. The method according to claim 3, wherein said flare model is configured from a rectangular model.
